(19) United States
(12) Patent Application Publication
(10) Pub. No.: US 2024/0001664 A1
(43) Pub. Date: Jan. 4, 2024

(54) HEAT DISSIPATION SHEET AND METHOD OF MANUFACTURING THE SAME

(71) Applicant: TERASYS.CO.,LTD, Uiwang-si (KR)

(72) Inventors: Jong Un PARK, Yongin-si (KR); Chi Young CHOI, Uiwang-si (KR)

(73) Assignee: TERASYS.CO.,LTD, Uiwang-si (KR)

(21) Appl. No.: 18/338,990

(22) Filed: Jun. 21, 2023

(30) Foreign Application Priority Data
Jun. 29, 2022 (KR) 10-2022-0079368

(51) Int. Cl. B32B 37/26; B32B 27/08; B32B 27/28; B32B 33/00; B32B 38/00

(52) U.S. Cl. CPC B32B 37/26; B32B 27/08; B32B 27/281; B32B 33/00; B32B 38/0036; B32B 2037/268; B32B 2307/514

(57) ABSTRACT

A method of manufacturing a heat dissipation sheet comprises arranging a pair of PI-films to be spaced apart in a horizontal direction, forming a pair of PI-film laminates by laminating PI-films, respectively, drying the PI-film, disposing a first release film having a metal thin film formed on a predetermined region on the upper surface of the PI film, attaching a second release film having a double-sided tape formed thereon to a lower surface of one of the PI-film, firstly rolling an upper surface of the first release film and a lower surface of the second release film by rolling rollers, removing the first release film and the second release film from the PI-film, respectively, folding the PI-film laminates based on points spaced apart, and manufacturing a heat dissipation sheet made of a multi-layered PI-film by performing secondary rolling on surfaces of the folded PI-film laminate with the rolling rollers.

### CROSS REFERENCE TO RELATED APPLICATION

This application claims priority from and the benefit of Korean Patent Applications No. 10-2022-0079368, filed on Jun. 29, 2022, which is hereby incorporated by reference for all purposes as if fully set forth herein.

### BACKGROUND OF THE INVENTION

### Field of the Invention

The present invention relates to a heat dissipation sheet that improves thermal conductivity in a vertical direction and a method of manufacturing the heat dissipation sheet.

### DISCUSSION OF THE BACKGROUND

People of all ages and genders frequently use electronic products such as computers and smartphones in their daily lives. These electronic products generate heat inside during use, and if the heat generated at this time is not smoothly diffused to the outside, the lifespan of the product is greatly shortened.

In particular, when using an electronic product, heat generated inside causes product failure or malfunction. In addition, in severe cases, heat inside the electronic product may explode or cause a fire, so the issue of efficiently dissipating heat generated from the electronic product is very important.

Conventionally, in order to efficiently control heat generated from electronic products, a heat radiation fin, a heat radiation sheet, and a heat sink are provided inside the electronic product. However, since the amount of heat that the heat sink can emit is smaller than the amount of heat from the heating element of the electronic product, the efficiency is very low, so the heat sink and the heat sink had to be installed together.

However, due to the simultaneous installation of a heat sink and a heat dissipation fan in an electronic product, noise and vibration problems from the heat dissipation fan additionally occur, and in addition, it cannot keep up with the design trend of electronic products that are gradually becoming lighter and slimmer. As a heat dissipation means, a heat dissipation sheet is receiving a lot of attention.

However, even in the case of such a heat radiation sheet, thermal conductivity in the horizontal direction is high, whereas thermal conductivity in the vertical direction is very low compared to the horizontal direction. For example, when artificial graphite is used as a heat radiation sheet, the thermal conductivity in the horizontal direction is 1000 to 1800 W/mk, whereas the thermal conductivity in the vertical direction is about 20 W/mk, so that the horizontal direction within the heat radiation sheet There was a problem that there was a significant difference in thermal conductivity between the vertical direction and the vertical direction.

Therefore, various methods for increasing the thermal conductivity in the vertical direction with respect to the heat radiation sheet have been studied.

### SUMMARY OF THE INVENTION

Therefore, the present invention provides a heat dissipation sheet capable of increasing thermal conductivity in the vertical direction and a manufacturing method thereof.

A method of manufacturing a heat dissipation sheet, according to an exemplary embodiment of the present invention comprises arranging a pair of PI films to be spaced apart by a predetermined distance in a horizontal direction, forming a pair of PI film laminates by laminating a plurality of PI films on the pair of PI films, respectively, drying the pair of PI film laminates, followed by carbonization and graphitization, disposing a first release film having a metal thin film formed on a predetermined region on one surface of the upper surface of the pair of PI film laminates, attaching a second release film having a double-sided tape formed thereon to a lower surface of one of the pair of PI film laminates, firstly rolling an upper surface of the first release film and a lower surface of the second release film by a pair of rolling rollers, removing the first release film and the second release film from the pair of PI film laminates, respectively, folding the pair of PI film laminates based on points spaced apart by a predetermined distance, and manufacturing a heat dissipation sheet made of a multi-layered PI film laminate by performing secondary rolling on the upper and lower surfaces of the folded PI film laminate with the pair of rolling rollers.

For example, in disposing a first release film having a metal thin film formed on a predetermined region on one surface of the upper surface of the pair of PI film laminates, the metal thin film formed on the first release film is positioned to correspond to the section where the pair of PI film laminates are spaced apart, so that both ends of the metal thin film are in contact with the upper surfaces of the pair of PI film laminates, respectively.

For example, the metal thin film has unevenness formed on one surface that comes into contact with the upper surface of the pair of PI film laminates.

For example, the metal thin film is made of a metal material having an elongation property.

For example, manufacturing a heat dissipation sheet made of a multi-layered PI film laminate by performing secondary rolling on the upper and lower surfaces of the folded PI film laminate with the pair of rolling rollers, comprises manufacturing a heat dissipation sheet made of a multi-layered PI film laminate by performing secondary rolling on the upper and lower surfaces of the folded PI film laminate with the pair of rolling rollers, such that the folded PI film laminates are adhered to each other in the vertical direction by the double-sided tape.

A method of heat dissipation sheet according to another exemplary embodiment of the present invention, comprises arranging a pair of PI films to be spaced apart by a predetermined distance in a horizontal direction, forming a pair of PI film laminates by laminating a plurality of PI films on the pair of PI films, respectively, forming a stepped region at a point spaced apart by a predetermined distance in a horizontal direction between the pair of PI film laminates, drying the pair of PI film laminates, followed by carbonization and graphitization, disposing a first release film having a metal thin film formed on a predetermined region on one surface of the upper surface of the pair of PI film laminates, attaching a second release film having a double-sided tape formed thereon to a lower surface of one of the pair of PI film laminates, firstly rolling an upper surface of the first release film and a lower surface of the second release film by a pair of rolling rollers, removing the first release film and the second release film from the pair of PI film laminates, respectively, folding the pair of PI film laminates based on points spaced apart by a predetermined distance, and manufacturing a heat dissipation sheet made of a multi-layered PI film laminate by performing secondary rolling on the upper and lower surfaces of the folded PI film laminate with the pair of rolling rollers.

As described above, the heat dissipation sheet and the manufacturing method according to the present invention fold the PI film laminate to produce a heat dissipation sheet composed of a multi-layer PI film laminate, thereby further enhancing the heat dissipation effect in the vertical direction as well as the horizontal direction.

### BRIEF DESCRIPTION OF THE DRAWINGS

FIG. 1A to FIG. 1G are cross-sectional views showing each step according to a method of manufacturing a heat dissipation sheet according to an exemplary embodiment of the present invention.

FIG. 2A to FIG. 2G are cross-sectional views showing each step according to a method of manufacturing a heat dissipation sheet according to another exemplary embodiment of the present invention.

### DETAILED DESCRIPTION OF THE ILLUSTRATED EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, etc. may be used herein to describe various elements, these elements should not be limited by these terms. These terms are only used to distinguish one element from another element. For example, a first element discussed below could be termed a second element, and similarly, a second element may also be termed a first element, without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups thereof but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention relates to a functional sheet manufactured through a powder spray method capable of enhancing safety and function due to not using an organic solvent which is harmful to the human body, and a method for manufacturing the functional sheet.

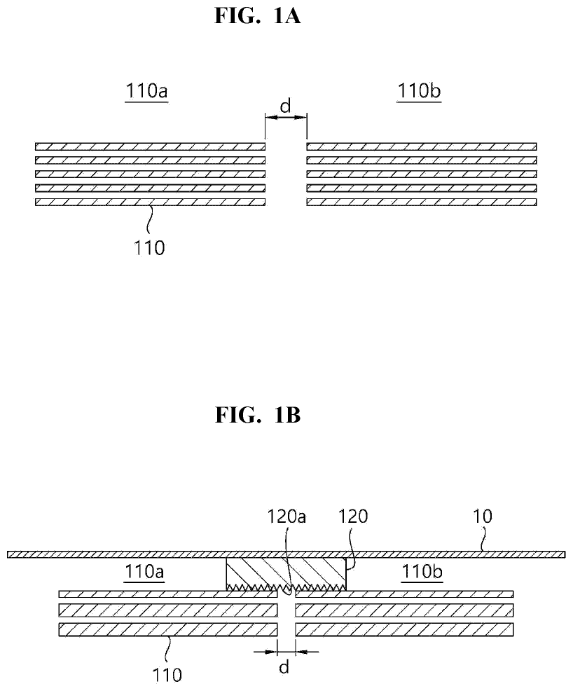

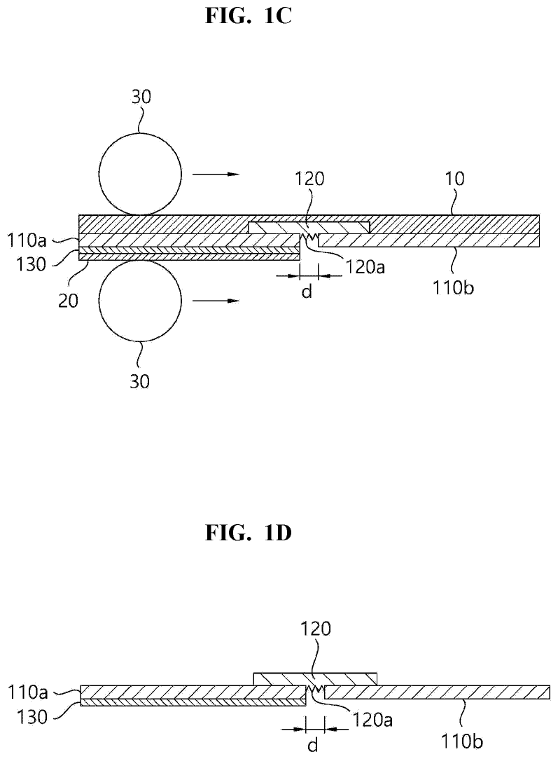

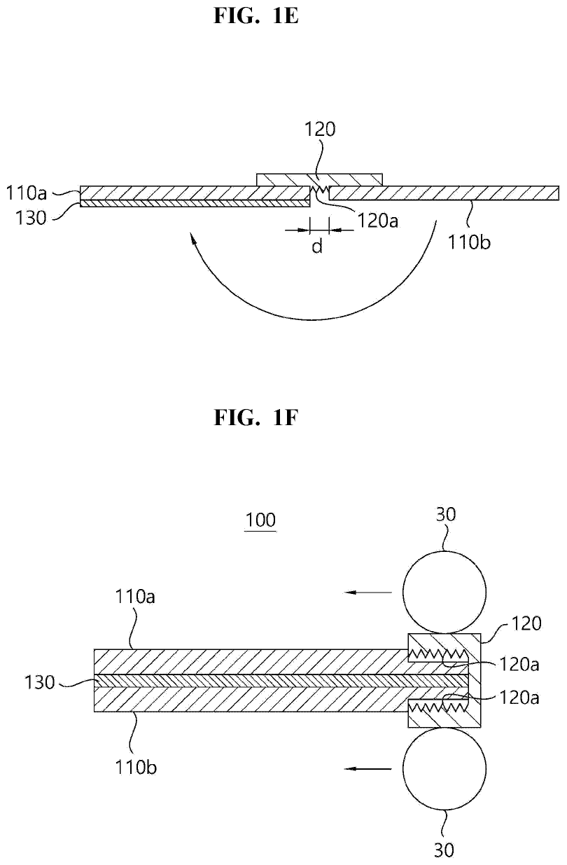

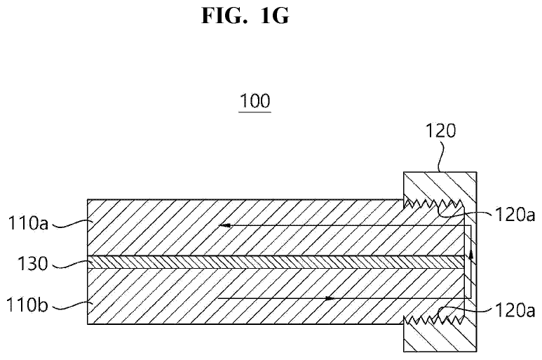

Hereinafter, referring to FIG. 1, a method of manufacturing a functional sheet through a powder spray method according to an embodiment of the present invention will be described in more detail.

FIG. 1A to FIG. 1G are cross-sectional views showing each step according to a method of manufacturing a heat dissipation sheet according to an exemplary embodiment of the present invention.

As shown in FIG. 1A, in the manufacturing method of a heat dissipation sheet according to an embodiment of the present invention, a robot arm arranges a pair of PI (Polyimide) films 110, which are precursors of a graphite sheet, in a horizontal direction. They are placed on the mounting table to be separated by a distance (d).

Thereafter, the robot arm laminates a plurality of PI films 110 on the pair of PI films 110 spaced apart by a predetermined distance (d), respectively, and a pair of PI film stacks (110a, 110b).

Subsequently, the robot arm moves the pair of PI film stacks 110a and 110b to a chamber to dry them for a certain period of time, and then moves them to an electric furnace to dry the pair of PI film stacks 110a and 110b thereby carbonizing and graphitizing the pair of PI film stacks 110a and 110b. In this case, the carbonization process for the pair of PI film laminates 110a and 110b may be performed at a temperature of 800 to 2400° C., and the graphitization process may be performed at a temperature of 2400 to 2800° C.

Thereafter, as shown in FIG. 1B, the robot arm applies the first release film 10 in which the metal thin film 120 is formed in a predetermined area on one side of the upper surface of the pair of PI film laminates 110a and 110b. place At this time, the metal thin film 120 formed on the first release film 10 is positioned to correspond to a section in which the pair of PI film stacks 110a and 110b are separated by a predetermined distance (d), and the metal thin film 120 may be disposed so as to contact upper surfaces of the pair of PI film laminates 110a and 110b, respectively. That is, one end of the metal thin film 120 comes into contact with the upper surface of one PI film stack 110a among the pair of PI film stacks 110a and 110b. In addition, the central portion of the metal thin film 120 is located between the pair of PI film stacks 110a and 110b spaced apart, and the other end of the metal thin film 120 is the pair of PI film stacks (110a, 110b). 110b) may come into contact with the upper surface of the other PI film laminate 110b. In particular, the metal thin film 120 may have irregularities 120a formed on one surface of the pair of PI film laminates 110a and 110b in contact with each other, and may be made of a metal material having an elongation property.

In particular, as the unevenness 120a is formed on one surface of the metal thin film 120 in contact with the upper surface of the pair of PI film stacks 110a and 110b, thereafter, the pair of PI film stacks 110a and 110b. In the rolling process after folding of 110b, adhesion and electrical conductivity between the metal thin film 120 and the pair of PI film laminates 110a and 110b may be further increased.

Subsequently, the robot arm attaches the second release film 20 on which the double-sided tape 130 is formed to the lower surface of one of the pair of PI film stacks 110a and 110b.

Then, as shown in FIG. 1C, a pair of PI film laminates 110a and 110b are disposed on a belt positioned between a pair of rolling rollers 30 facing each other.

Accordingly, the pair of rolling rollers 30 linearly move in the horizontal direction, and the upper surface of the first release film 10 disposed on the pair of PI film laminates 110a and 110b, and the lower surface of the second release film 20 is first rolled.

As shown in FIG. 1D, a gripper formed on a robot arm removes the first release film 10 and the second release film 20 from the pair of PI film laminates 110a and 110b, respectively.

Accordingly, the pair of PI film stacks 110a and 110b are spaced apart by a predetermined distance (d), and the upper surface of the spaced section is placed in contact with the pair of PI film stacks 110a and 110b, respectively. The thin film 120 protrudes and is attached, and the double-sided tape 130 is attached to the lower surface of one of the PI film stacks 110a and 110b of the pair of PI film stacks 110a and 110b.

In this state, as shown in FIG. 1E, the robot arm folds the pair of PI film laminates 110a and 110b based on a section spaced apart by a predetermined distance (d). At this time, the PI film stack 110b to which the double-sided tape is not attached to the lower surface may be moved downward in an in-folding manner and disposed to correspond to the PI film stack 110a to which the double-sided tape is attached.

Thereafter, the robot arm places the folded PI film laminates 110a and 110b on a belt positioned between a pair of rolling rollers 30.

Accordingly, as shown in FIG. 1F, the pair of rolling rollers 30 linearly move in the horizontal direction, and the upper and lower surfaces of the folded PI film laminates 110a and 110b and the metal thin film 120 The ends of the formed folded PI film laminates 110a and 110b are subjected to secondary rolling.

As such, as the pair of rolling rollers 30 secondarily roll the upper and lower surfaces of the folded PI film laminates 110a and 110b, the double-sided tape 130 forms the folded PI film. The laminates 110a and 110b may be bonded to each other in the vertical direction to manufacture the heat dissipation sheet 100 made of the multi-layer PI film laminates 110a and 110b. At this time, the manufactured heat dissipation sheet 100 is attached with a metal thin film 120 so as to surround one end of the folded PI film laminates 110a and 110b.

As a result, as shown in FIG. 1G, when the heat dissipation sheet 100 according to an embodiment of the present invention is disposed around the heating element in the electronic product, the heat generated from the heating element is transferred to the multi-layered PI in the heat dissipation sheet 100. Among the film stacks 110a and 110b, the PI film stack 110b is first conducted. Thereafter, the heat is conducted in a horizontal direction through the PI film laminate 110b located at the bottom, passes through the metal thin film 120 formed at the end of the heat dissipation sheet 100, and is located on the top of the heat dissipation sheet 100. It is conducted to the PI film laminate 110a and discharged to the outside.

That is, when a heat radiation sheet is manufactured by simply stacking PI films, heat diffusion is smoothly performed from one end to the other end of the heat radiation sheet, so that the thermal conductivity in the horizontal direction is good, but the thermal conductivity in the vertical direction is relatively low.

However, in the case of the present invention, as the heat dissipation sheet is formed in multiple layers by folding the PI film laminates 110a and 110b, the PI film laminate 110b located at the bottom, the metal thin film 120 located at the end, and the upper part as thermal diffusion is performed in a so-called zigzag manner moving in order of the PI film stack 110a located on the, thermal conductivity in the vertical direction as well as in the horizontal direction can be remarkably increased.

In addition, by forming an end region on the folded PI film stacks 110a and 110b and placing the metal thin film 120 thereon, the metal thin film 120 does not protrude from the surface of the PI film stacks 110a and 110b. It may be formed in a state inserted into the inside of the PI film laminates 110a and 110b.

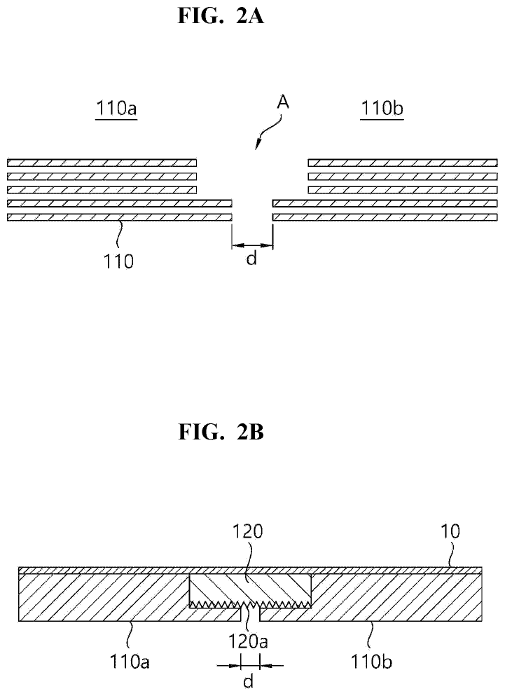

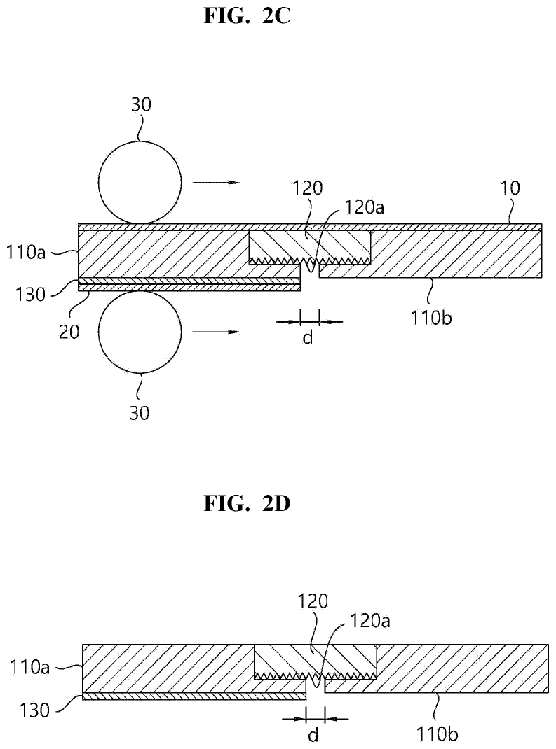

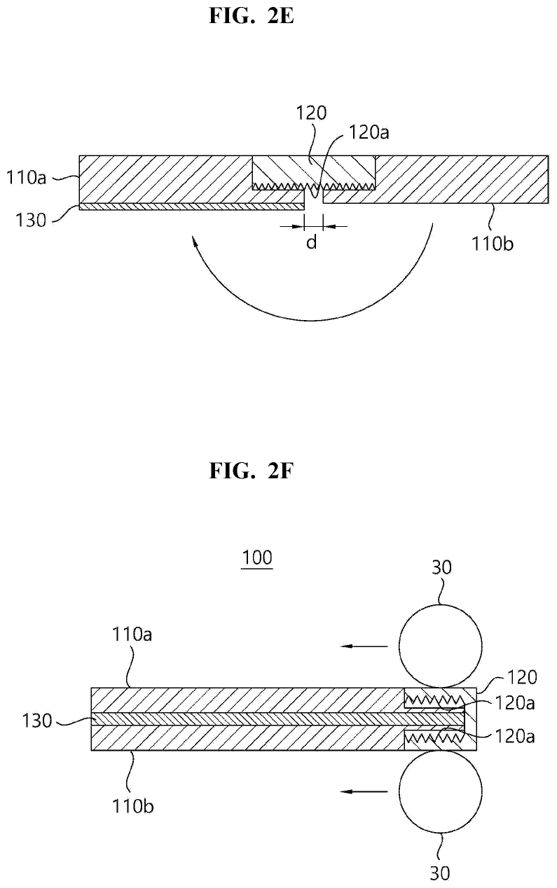

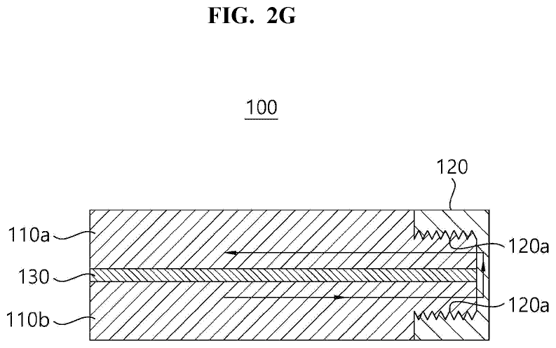

Hereinafter, with reference to FIG. 2A to FIG. 2G, a method of manufacturing a heat dissipation sheet according to another embodiment of the present invention will be described in detail.

FIG. 2A to FIG. 2G are cross-sectional views showing each step according to a method of manufacturing a heat dissipation sheet according to another exemplary embodiment of the present invention.

As shown in FIG. 2A, the robot arm places a pair of PI (Polyimide) films 110, which are precursors of graphite sheets, on a mounting table to be spaced apart by a predetermined distance (d) in the horizontal direction.

Thereafter, the robot arm laminates a plurality of PI films 110 on the pair of PI films 110 spaced apart by a predetermined distance (d), respectively, and a pair of PI film stacks 110a and 110b.

In this way, when the pair of PI film stacks 110a and 110b are formed in a state where they are spaced apart by a predetermined distance (d), the cutting device is placed between the pair of PI film stacks 110a and 110b at a predetermined distance (d). A stepped region (A) is formed by vertically cutting some of the PI films 110 stacked at spaced apart sections. That is, a stepped region A may be formed in a section where the pair of PI film laminates 110a and 110b are spaced apart from each other.

Thereafter, the robot arm moves the pair of PI film stacks 110a and 110b to a chamber to dry them for a certain period of time, and then moves them to an electric furnace to dry the pair of PI film stacks 110a and 110b, thereby carbonizing and graphitizing the pair of PI film stacks. In this case, the carbonization process for the pair of PI film laminates 110a and 110b may be performed at a temperature of 800 to 2400° C., and the graphitization process may be performed at a temperature of 2400 to 2800° C.

As shown in FIG. 2B, the robot arm places the first release film 10 in which the metal thin film 120 is formed in a predetermined area on one surface of the upper surface of the pair of PI film laminates 110a and 110b. At this time, the metal thin film 120 formed on the first release film 10 is positioned to correspond to a section in which the pair of PI film stacks 110a and 110b are separated by a predetermined distance (d), and the metal thin film 120 may be disposed so as to contact upper surfaces of the pair of PI film laminates 110a and 110b, respectively. That is, one end of the metal thin film 120 comes into contact with the upper surface of one PI film stack 110a among the pair of PI film stacks 110a and 110b. In addition, the central portion of the metal thin film 120 is located in a spaced section between the pair of PI film stacks 110a and 110b, and the other end of the metal thin film 120 is the pair of PI film stacks 110a and 110b. 110b) may come into contact with the upper surface of the other PI film laminate 110b. In particular, the metal thin film 120 may have irregularities 120a formed on one surface of the pair of PI film laminates 110a and 110b in contact with each other, and may be made of a metal material having an elongation property.

In particular, as the unevenness 120a is formed on one surface of the metal thin film 120 in contact with the upper surface of the pair of PI film stacks 110a and 110b, thereafter, the pair of PI film stacks 110a and 110b. In the rolling process after folding of 110b, adhesion and electrical conductivity between the metal thin film 120 and the pair of PI film laminates 110a and 110b may be further increased.

Subsequently, the robot arm attaches the second release film 20 on which the double-sided tape 130 is formed to the lower surface of one of the pair of PI film stacks 110a and 110b. At this time, the thickness of the double-sided tape 130 formed on the second release film 20 is 2 to 5 um.

Then, as shown in FIG. 2C, a pair of PI film laminates 110a and 110b are disposed on a belt positioned between a pair of rolling rollers 30 facing each other.

Accordingly, the pair of rolling rollers 30 linearly move in the horizontal direction, and the upper surface of the first release film 10 disposed on the pair of PI film laminates 110a and 110b, and the The lower surface of the second release film 20 is first rolled.

Then, as shown in FIG. 2D, the gripper formed on the robot arm removes the first release film 10 and the second release film 20 from the pair of PI film laminates 110a and 110b, respectively.

Accordingly, the pair of PI film laminates 110a and 110b are separated by a predetermined distance (d), and the metal thin film 12 is disposed inside the stepped region A formed in the spaced section. In addition, a double-sided tape 130 is attached to the lower surface of one of the PI film stacks 110a and 110b of the pair of PI film stacks 110a and 110b.

In this state, as shown in FIG. 2E, the robot arm folds the pair of PI film laminates 110a and 110b based on a section spaced apart by a predetermined distance (d). At this time, the PI film stack 110b to which the double-sided tape is not attached to the lower surface may be moved downward in an in-folding manner and disposed to correspond to the PI film stack 110a to which the double-sided tape is attached to the lower surface.

Thereafter, the robot arm places the folded PI film laminates 110a and 110b on a belt positioned between a pair of rolling rollers 30.

Accordingly, as shown in FIG. 2F, the pair of rolling rollers 30 linearly move in the horizontal direction, and the upper and lower surfaces of the folded PI film laminates 110a and 110b and the metal thin film 120 The ends of the formed folded PI film laminates 110a and 110b are subjected to secondary rolling.

As such, as shown in FIG. 2G, as the pair of rolling rollers 30 secondarily roll the upper and lower surfaces of the folded PI film laminates 110a and 110b, the double-sided tape (130), the folded PI film laminates 110a and 110b may be vertically adhered to each other to manufacture a heat dissipation sheet 100 composed of multiple PI film laminates 110a and 110b.

That is, in the heat dissipation sheet 100 manufactured through another embodiment of the present invention, a stepped region A is formed at a point where the pair of PI film laminates 110a and 110b are folded, and the stepped region A Discloses a configuration in which the metal thin film 120 fills. Therefore, among the upper and lower surfaces of the heat dissipation sheet 100, the end surface on which the metal thin film 120 is disposed does not protrude more than other surfaces, so that the upper and lower surfaces of the heat dissipation sheet 100 are evenly flattened.

In addition, in the heat dissipation sheet manufactured through the present invention, the PI film, which is the basis, can be implemented not only with artificial graphite, but also with materials such as natural graphite and expanded graphite.

In addition, the above-described embodiments disclose only a configuration in which a PI film laminate is formed in two layers by folding a pair of PI film laminates once, but a plurality of PI film laminates are spaced apart from each other at a predetermined distance. After attaching the metal thin film to each spaced section in the state, in-folding and out-folding are performed together, so that the PI film laminate can also implement a heat dissipation sheet composed of two or more multi-layers.

As described above, the heat dissipation sheet and the manufacturing method according to the present invention fold the PI film laminate to produce a heat dissipation sheet composed of a multi-layer PI film laminate, thereby further enhancing the heat dissipation effect in the vertical direction as well as the horizontal direction.

It will be apparent to those skilled in the art that various modifications and variation may be made in the present invention without departing from the spirit or scope of the invention. Thus, it is intended that the present invention cover the modifications and variations of this invention provided they come within the scope of the appended claims and their equivalents.

What is claimed is:

1. A method of manufacturing a heat dissipation sheet, comprising:
arranging a pair of PI films to be spaced apart by a predetermined distance in a horizontal direction;
forming a pair of PI film laminates by laminating a plurality of PI films on the pair of PI films, respectively;
drying the pair of PI film laminates, followed by carbonization and graphitization;
disposing a first release film having a metal thin film formed on a predetermined region on one surface of the upper surface of the pair of PI film laminates;
attaching a second release film having a double-sided tape formed thereon to a lower surface of one of the pair of PI film laminates;
firstly rolling an upper surface of the first release film and a lower surface of the second release film by a pair of rolling rollers;
removing the first release film and the second release film from the pair of PI film laminates, respectively;
folding the pair of PI film laminates based on points spaced apart by a predetermined distance; and
manufacturing a heat dissipation sheet made of a multi-layered PI film laminate by performing secondary rolling on the upper and lower surfaces of the folded PI film laminate with the pair of rolling rollers.

2. The method of claim 1, wherein in disposing a first release film having a metal thin film formed on a predetermined region on one surface of the upper surface of the pair of PI film laminates,
the metal thin film formed on the first release film is positioned to correspond to the section where the pair of PI film laminates are spaced apart, so that both ends of the metal thin film are in contact with the upper surfaces of the pair of PI film laminates, respectively.

3. The method of claim 1, wherein the metal thin film has unevenness formed on one surface that comes into contact with the upper surface of the pair of PI film laminates.

4. The method of claim 3, wherein the metal thin film is made of a metal material having an elongation property.

5. The method of claim 1, wherein manufacturing a heat dissipation sheet made of a multi-layered PI film laminate by performing secondary rolling on the upper and lower surfaces of the folded PI film laminate with the pair of rolling rollers, comprises:
manufacturing a heat dissipation sheet made of a multi-layered PI film laminate by performing secondary rolling on the upper and lower surfaces of the folded PI film laminate with the pair of rolling rollers, such that the folded PI film laminates are adhered to each other in the vertical direction by the double-sided tape.

6. A method of heat dissipation sheet, comprising:
arranging a pair of PI films to be spaced apart by a predetermined distance in a horizontal direction;
forming a pair of PI film laminates by laminating a plurality of PI films on the pair of PI films, respectively;
forming a stepped region at a point spaced apart by a predetermined distance in a horizontal direction between the pair of PI film laminates;
drying the pair of PI film laminates, followed by carbonization and graphitization;
disposing a first release film having a metal thin film formed on a predetermined region on one surface of the upper surface of the pair of PI film laminates;
attaching a second release film having a double-sided tape formed thereon to a lower surface of one of the pair of PI film laminates;
firstly rolling an upper surface of the first release film and a lower surface of the second release film by a pair of rolling rollers;
removing the first release film and the second release film from the pair of PI film laminates, respectively;
folding the pair of PI film laminates based on points spaced apart by a predetermined distance; and
manufacturing a heat dissipation sheet made of a multi-layered PI film laminate by performing secondary rolling on the upper and lower surfaces of the folded PI film laminate with the pair of rolling rollers.

7. The method of claim 6, wherein the metal thin film formed on the first release film has same height as the height of the stepped region formed between the pair of PI film laminates.

8. A heat dissipation sheet manufactured by the method of manufacturing a heat-radiating sheet of claim 1.
